(19) United States
(12) Patent Application Publication
(10) Pub. No.: US 2018/0025050 A1
(43) Pub. Date: Jan. 25, 2018

(54) METHODS AND SYSTEMS TO DETECT DISENGAGEMENT OF USER FROM AN ONGOING

(71) Applicant: YEN4KEN,INC., Princeton, NJ (US)

(72) Inventors: Kuldeep Yadav, Gurgaon (IN); Arijit Biswas, Kolkata (IN); Kundan Shrivastava, Bangalore (IN); Om D Deshmukh, Bangalore (IN); Kushal Srivastava, Lucknow (IN); Deepali Jain, New Delhi (IN)

(21) Appl. No.: 15/215,638

(22) Filed: Jul. 21, 2016

(51) Int. Cl. G06F 17/30; G06F 3/0482

(52) U.S. Cl. CPC G06F 17/30398; G06F 17/30029; G06F 17/30058; G06F 3/0482

(57) ABSTRACT

A method and a system to detect disengagement of a first user viewing an ongoing multimedia content on a user computing device are disclosed. In an embodiment, one or more activity-based contextual cues and one or more behavior-based contextual cues of the first user viewing the ongoing multimedia content on the first user-computing device are received. Further, the disengagement of the first user is detected based on the one or more activity-based contextual cues and/or and one or more behavior-based contextual cues. Based on the detected disengagement of the first user, one or more queries are rendered on a user interface displayed on a display screen of the first user-computing device.

### TECHNICAL FIELD

The presently disclosed embodiments are related, in general, to computer-assisted learning. More particularly, the presently disclosed embodiments are related to methods and systems to detect disengagement of a user from an ongoing multimedia content requiring occasional active interaction of the user.

### BACKGROUND

Advancements in the field of online education have led to the emergence of Massive Open Online Courses (MOOCs) as one of the popular modes of learning. Most of the material available through the MOOCs include multimedia content, such as a video recordings. The MOOCs offer free online courses delivered by qualified instructors from world-known institutes and attended by millions of remotely located users. Such users may view the multimedia content to develop skills and gain knowledge. However, it has been observed that, most of the users usually feel disengaged and loose interest in the concept or topic being discussed while watching the multimedia content.

Usually, to better engage a user with the multimedia content, one or more queries are presented to the user at specific time intervals, before proceeding to the next concept or topic in the multimedia content. However, the presentation of such one or more queries in the multimedia content may not engage the user due to many reasons, such as a fixed locations of the query, same query provided to each user, and/or the like. Therefore, one or more dynamic and personalized queries are required in the multimedia content for engaging the user and for better retention.

Further limitations and disadvantages of conventional and traditional approaches will become apparent to a person having ordinary skill in the art through a comparison of the described systems with some aspects of the present disclosure, as set forth in the remainder of the present application and with reference to the drawings.

### SUMMARY

According to embodiments illustrated herein there is provided a method to detect disengagement of a user from an ongoing multimedia content requiring occasional active interaction. The method includes receiving, by one or more transceivers at a computing server, one or more activity-based contextual cues of the first user viewing the ongoing multimedia content on a first user-computing device. The method further includes detecting, by one or more processors at the computing server, the disengagement of the first user during one or more predefined time intervals associated with the ongoing multimedia content based on the one or more activity-based contextual cues. The method further includes rendering, by the one or more processors, one or more queries, based on the detected disengagement of the first user, on a user interface displayed on a display screen of the first user-computing device. The one or more queries are determined based on at least a portion of the ongoing multimedia content that corresponds to the one or more predefined time intervals.

According to embodiments illustrated herein there is provided a system to detect disengagement of a user from an ongoing multimedia content requiring occasional active interaction. The system includes one or more transceivers at a computing server that are configured to receive one or more activity-based contextual cues of the first user viewing the ongoing multimedia content on a user computing device. The system further includes one or more processors at the computing server that are configured to detect the disengagement of the first user during one or more predefined time intervals associated with the ongoing multimedia content based on the one or more activity-based contextual cues. The one or more processors are further configured to render one or more queries, based on the detected disengagement of the first user, on a user interface displayed on a display screen of the user computing device. The one or more queries are determined based on at least a portion of the ongoing multimedia content that corresponds to the one or more predefined time intervals.

According to embodiments illustrated herein there is provided a computer program product for use with a computer, the computer program product comprising a non-transitory computer readable medium, wherein the non-transitory computer readable medium stores a computer program code to detect disengagement of a user from an ongoing multimedia content requiring occasional active interaction. The computer program code is executable by one or more processors in a computing server to receive one or more activity-based contextual cues and one or more behavior-based contextual cues of the first user viewing the ongoing multimedia content on a user computing device. The computer program code is further executable, by the one or more processors, to detect the disengagement of the first user during one or more predefined time intervals associated with the ongoing multimedia content based on at least the one or more activity-based contextual cues and the one or more behavior-based contextual cues. The computer program code is further executable, by the one or more processors, to render one or more queries, based on the detected disengagement of the first user, on a user interface displayed on a display screen of the user computing device. The one or more queries are determined based on at least a portion of the ongoing multimedia content that corresponds to the one or more predefined time intervals.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 is a block diagram that illustrates a system environment in which various embodiments may be implemented;

FIG. 2 is a block diagram that illustrates various components of a computing server for detecting user disengagement, in accordance with at least one embodiment;

FIG. 3 is a flowchart that illustrates a method for detecting user disengagement, in accordance with at least one embodiment;

FIG. 4A is an exemplary user interface that is rendered on a second user-computing device to search multimedia content, in accordance with an embodiment;

FIG. 4B is an exemplary user interface that is rendered on a second user-computing device to add one or more queries, in accordance with an embodiment; and

FIG. 4C is an exemplary user interface that is rendered on a first user-computing device based on detected disengagement of a first user, in accordance with an embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment,” “an embodiment,” “at least one embodiment,” “one example,” “an example,” “for example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### Definitions

The following terms shall have, for the purposes of this application, the respective meanings set forth below.

A “user-computing device” refers to a computer, a device (that includes one or more processors/microcontrollers and/or any other electronic components), or a system (that performs one or more operations according to one or more sets of programming instructions, codes, or algorithms) associated with a user. In an embodiment, the user may utilize the user-computing device to transmit one or more requests. Examples of the user-computing device may include, but are not limited to, a desktop computer, a laptop, a personal digital assistant (PDA), a mobile device, a smartphone, and a tablet computer (e.g., iPad® and Samsung Galaxy Tab®).

“Multimedia content” refers to content that uses a combination of different content forms, such as text content, audio content, image content, animation content, video content, and/or interactive content. In an embodiment, the multimedia content may be reproduced on a user-computing device through an application, such as a media player (e.g., Windows Media Player®, Adobe® Flash Player, Apple® QuickTime®, and/or the like). In an embodiment, the multimedia content may be downloaded from a server to the user-computing device. In an alternate embodiment, the multimedia content may be retrieved from a media storage device, such as a hard disk drive (HDD), CD drive, pen drive, and/or the like, connected to (or inbuilt within) the user-computing device.

A “first user” refers to an individual who may watch or view multimedia content on a first user-computing device. The first user-computing device is a user-computing device associated with the first user. Examples of the first user may include, but are not limited to, a student, a learner, a customer, a consumer, a client, and/or the like.

A “second user” refers to an individual who may determine one or more queries based on one or more portions or concepts of multimedia content. In an embodiment, the second user may utilize a second user-computing device to transmit the determined one or more queries to a computing server. In another embodiment, the second user may utilize the second user-computing device to associate each of the determined one or more queries with a time interval that is associated with a corresponding portion or concept in the multimedia content. Examples of the second user may include, but are not limited to, an instructor, a subject expert, a trainer, a teacher, and/or the like.

“User disengagement” refers to a state of detachment of a user from an ongoing activity. In an embodiment, the disengagement of the user may result from an action of the user (or other users) that causes the user to withdraw from involvement in the ongoing activity. In an embodiment, the disengagement of the user may be detected based on one or more activity-based contextual cues and/or one or more behavior-based contextual cues.

“One or more activity-based contextual cues” refer to information pertaining to one or more activities of a user, when the user is viewing an ongoing multimedia content on a user-computing device. In an embodiment, the one or more activity-based contextual cues may be detected by one or more sensors associated with the user-computing device. Examples of the one or more activity-based contextual cues may include one or more of, but are not limited to, an interaction of a user with one or more input/output (I/O) devices (e.g., keyboard, mouse, and/or the like) of a user-computing device, an interaction of the user with an ongoing multimedia content (e.g., pause, fast-forward, timeline scrubbing, and/or the like), a tracking of an application usage by the user, and a presence of the user in front of the user-computing device.

“One or more behavior-based contextual cues” refer to information pertaining to one or more behavioral attributes of a user, when the user is viewing an ongoing multimedia content on a user-computing device. In an embodiment, the one or more behavior-based contextual cues may be detected by one or more sensors associated with the user-computing device. Examples of the one or more behavior-based contextual cues may include one or more of, but are not limited to, a facial expression, an emotion, an eye gaze, and an eye blinking of the first user.

A “sensor” refers to an electronic device that is configured to detect or measure one or more activity-based contextual cues and/or one or more behavior-based contextual cues of a user, when the user is viewing an ongoing multimedia content on a user-computing device. In an embodiment, the sensor may be configured to track changes in activities or behaviors of the user, when the user is viewing the ongoing multimedia content. In an embodiment, the sensor may be embedded in one or more components of the user-computing device. In another embodiment, the sensor may be externally connected with the user-computing device. Examples of the sensor include at least one of, but is not limited to, a touch sensor, a pressure sensor, an image capturing sensor, an accelerometer sensor, a microphone sensor, and a passive infrared (IR) sensor.

“One or more queries” refer to one or more questions that may be asked to a user. In an embodiment, the one or more queries may be asked to the user based on a detection of disengagement of the user who is viewing an ongoing multimedia content on the user-computing device. In an embodiment, the one or more queries may be associated with one or more portions or concepts, associated with a corresponding time interval, of the ongoing multimedia content. In another embodiment, the one or more queries may correspond to one or more personalized questions that have been determined based on at least historical contextual cues of the user.

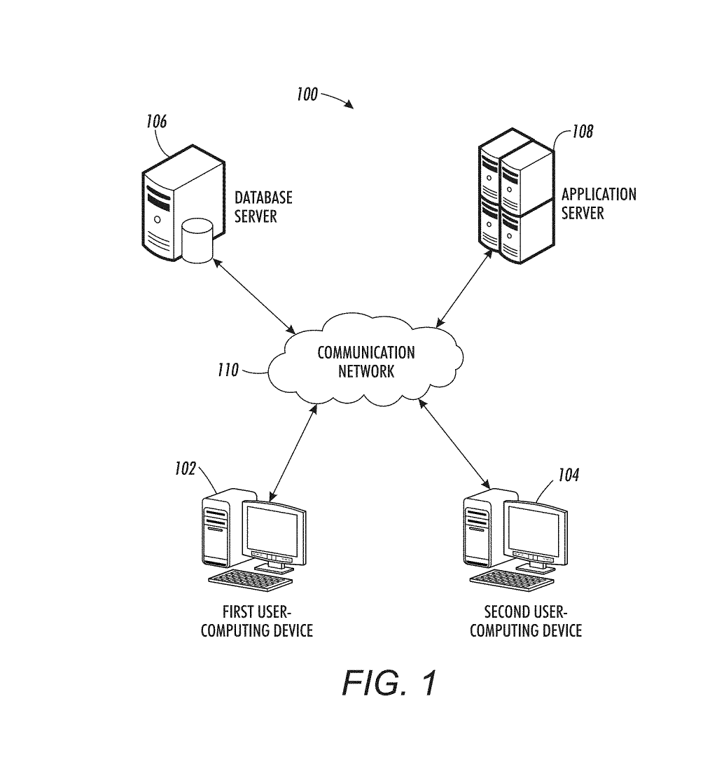

FIG. 1 is a block diagram that illustrates a system environment in which various embodiments may be implemented. With reference to FIG. 1, there is shown a system environment 100 that includes a first user-computing device 102, a second user-computing device 104, a database server 106, an application server 108, and a communication network 110. Various devices and servers in the system environment 100 may be interconnected over the communication network 110. FIG. 1 shows, for simplicity, one first user-computing device 102, one second user-computing device 104, one database server 106, and one application server 108. However, it will be apparent to a person having ordinary skill in the art that the disclosed embodiments may also be implemented using multiple first user-computing devices, multiple second user-computing devices, multiple database servers, and multiple application servers without departing from the scope of the disclosure.

The first user-computing device 102 may refer to a computing device (associated with a first user) that may be communicatively coupled to the communication network 110. The first user may correspond to an individual, such as a student, a learner, a customer, a consumer, a client, and/or the like, who may utilize the first user-computing device 102 to watch or view multimedia content. The first user-computing device 102 may comprise one or more processors in communication with one or more memory units. The first user-computing device 102 may further be associated with one or more sensors. In an embodiment, the one or more sensors may be embedded inside the first user-computing device 102. In another embodiment, the one or more sensors may be connected externally to the first user-computing device 102. Further, in an embodiment, the one or more processors and the one or more sensors may be operable to execute one or more sets of computer readable codes, instructions, programs, or algorithms, stored in the one or more memory units, to perform one or more associated operations.

In an embodiment, the first user-computing device 102 is communicatively connected with other computing devices, such as the second user-computing device 104, and one or more computing servers, such as the database server 106 and/or the application server 108, over the communication network 110. In an embodiment, the first user may utilize the first user-computing device 102 to transmit a request for the multimedia content to the second user-computing device 104 or the application server 108 over the communication network 110. Thereafter, the first user may utilize the first user-computing device 102 to receive the multimedia content from the second user-computing device 104 or the application server 108 over the communication network 110. After receiving the multimedia content, the first user may utilize the first user-computing device 102 to view the received multimedia content. In another embodiment, the first user may receive a link (e.g., a hyperlink) pertaining to the multimedia content from the second user-computing device 104 or the application server 108 over the communication network 110. The first user may open the link to view the requested multimedia content over the communication network 110.

While the first user is viewing the requested multimedia content on the first user-computing device 102, the one or more sensors associated with the first user-computing device 102 may be operable to detect or measure one or more activity-based contextual cues and one or more behavior-based contextual cues of the first user. Examples of the one or more activity-based contextual cues may include one or more of, but are not limited to, an interaction of a user with one or more input/output (I/O) devices (e.g., keyboard, mouse, and/or the like) of a user-computing device, an interaction of the user with an ongoing multimedia content (e.g., pause, fast-forward, timeline scrubbing, and/or the like), a tracking of an application usage by the user, and a presence of the user in front of the first user-computing device 102. Examples of the one or more behavior-based contextual cues may include one or more of, but are not limited to, a facial expression, an emotion, an eye gaze, and an eye blinking of the first user. Thereafter, the one or more sensors may store the one or more activity-based contextual cues and the one or more behavior-based contextual cues of the first user in the one or more memory units of the first user-computing device 102.

Further, in an embodiment, the first user may utilize the first user-computing device 102 to respond to one or more queries associated with one or more portions of the ongoing multimedia content. The first user-computing device 102 may correspond to various types of computing devices, such as, but are not limited to, a desktop computer, a laptop, a PDA, a mobile device, a smartphone, a tablet computer (e.g., iPad® and Samsung Galaxy Tab®), a data center, and/or the like.

The second user-computing device 104 may refer to a computing device (associated with a second user) that may be communicatively coupled to the communication network 110. The second user may correspond to an individual, such as a teacher, an instructor, a trainer, a subject expert, and/or the like. In an embodiment, the second user-computing device 104 may comprise one or more processors in communication with one or more memory units. The one or more memory units may include one or more computer readable codes, instructions, programs, or algorithms that are executable by the one or more processors to perform one or more associated operations.

In an embodiment, the second user may utilize the second user-computing device 104 to search for the multimedia content on the database server 106. The second user may input one or more keywords or concepts to search for the multimedia content. Further, in an embodiment, the second user may utilize the second user-computing device 104 to determine one or more common queries based on at least content in the one or more portions (associated with one or more pre-defined time intervals) of the multimedia content. The one or more common queries determined by the second user may be common to each of one or more first users. In another embodiment, the second user may determine one or more personalized queries for each of the one or more first users. The second user may utilize historical contextual cues of each of the one or more first users to determine the one or more personalized queries. For example, historical contextual cues of a first user indicates that the first user fast forwards multimedia content during a time interval of “20-40 minutes” of the multimedia content. Based on such historical contextual cues, a second user may determine one or more queries based on content associated with the time interval of “20-40 minutes” of the multimedia content. Hereinafter, the determined one or more common queries and the determined one or more personalized queries have been referred to as the one or more queries.

Further, in an embodiment, the second user may utilize the second user-computing device 104 to transmit the multimedia content to the first user-computing device 102, the database server 106, or the application server 108 over the communication network 110. The second user may further utilize the second user-computing device 104 to transmit the determined one or more queries to the database server 106 or the application server 108 over the communication network 110. Further, in an embodiment, the second user may transmit an association of the one or more queries with the one or more pre-defined time intervals to the database server 106 or the application server 108. Further, in an embodiment, the second user may utilize the second user-computing device 104 to transmit one or more pre-defined responses of the one or more queries to the database server 106 or the application server 108 over the communication network 110. Further, in an embodiment, the second user may utilize the second user-computing device 104 to transmit one or more pre-defined criteria that may be utilized by the application server 108 to detect the disengagement of the first user. The second user-computing device 104 may correspond to various types of computing devices, such as, but are not limited to, a desktop computer, a laptop, a PDA, a mobile device, a smartphone, a tablet computer (e.g., iPad® and Samsung Galaxy Tab®), a data center, and/or the like.

The database server 106 may refer to a computing device that may be communicatively coupled to the communication network 110. In an embodiment, the database server 106 may be configured to maintain a repository of multimedia content. The database server 106 may further be configured to store the determined one or more queries associated with each multimedia content in the repository of multimedia content. Further, in an embodiment, the database server 106 may be configured to maintain a data structure that includes one-to-one mapping between various parameters of the one or more queries. For example, for each query, the database server 106 may be configured to maintain a mapping with an associated content, an associated portion, an associated time interval, and an associated pre-defined response.

Further, in an embodiment, the database server 106 may be configured to receive the request, for the retrieval of the multimedia content, from the first user-computing device 102 or the application server 108. Thereafter, the database server 106 may be configured to transmit the multimedia content to the first user-computing device 102 or the application server 108 based on the received request. For querying the database server 106, one or more querying languages may be utilized, such as, but not limited to, SQL, QUEL, and DMX. In an embodiment, the database server 106 may connect to the application server 108, using one or more protocols, such as, but not limited to, ODBC and JDBC.

The application server 108 may refer to a computing device or a software framework hosting an application or a software service that may be communicatively coupled to the communication network 110. In an embodiment, the application server 108 may be implemented to execute procedures, such as, but not limited to, one or more sets of programs, routines, or scripts stored in one or more memory units for supporting the hosted application or the software service. In an embodiment, the hosted application or the software service may be configured to perform one or more pre-defined operations. The one or more pre-defined operations of the application server 108 may include transmitting the multimedia content to the first user-computing device 102 based on a request received from the first user-computing device 102 or the second user-computing device 104. Thereafter, the application server 108 may be operable to receive the one or more activity-based contextual cues and the one or more behavior-based contextual cues of the first users from the one or more sensors associated with the first user-computing device 102 over the communication network 110. The application server 108 may receive the one or more activity-based contextual cues and the one or more behavior-based contextual cues of the first user pertaining to each of the one or more pre-defined time intervals, when the first user is viewing the ongoing multimedia content on the first user-computing device 102 over the communication network 110. Further, the application server 108 may be configured to detect the disengagement of the first user during each of the one or more pre-defined time intervals based on the one or more activity-based contextual cues and/or the one or more behavior-based contextual cues.

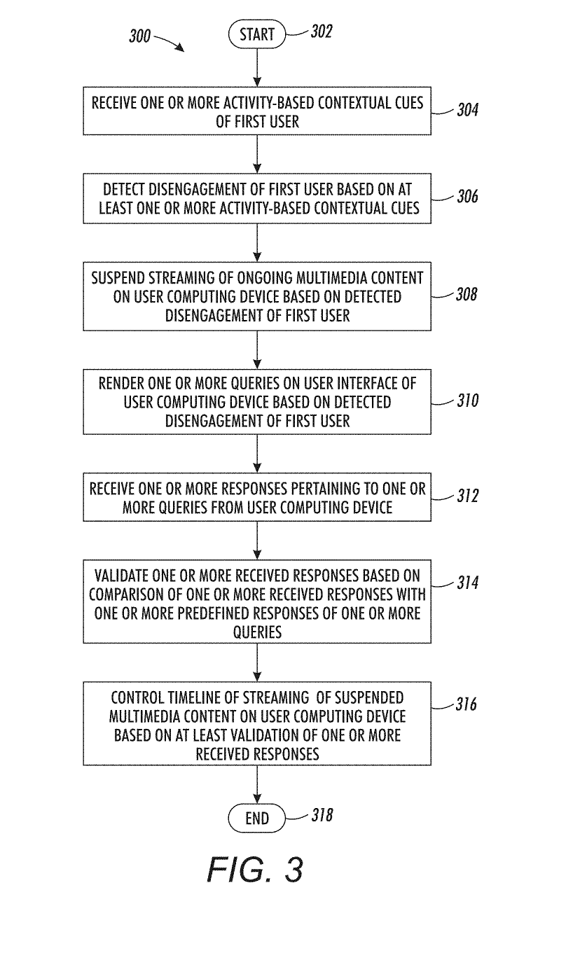

After the detection of the disengagement of the first user during the one or more pre-defined time interval of the ongoing multimedia content, the application server 108 may be operable to suspend streaming of the ongoing multimedia content on the first user-computing device 102. Thereafter, the application server 108 may be operable to render the one or more queries on a user interface displayed on a display screen of the first user-computing device 102. Further, the application server 108 may be operable to facilitate user interaction for the first user. For example, application server 108 may receive one or more responses, pertaining to the one or more queries, from the first user-computing device 102. Thereafter, the application server 108 may be operable to control the streaming of the suspended multimedia content on the first user-computing device 102 based on validation of the received one or more responses. The one or more pre-defined operations of the application server 108 has been explained in detail in conjunction with FIG. 3.

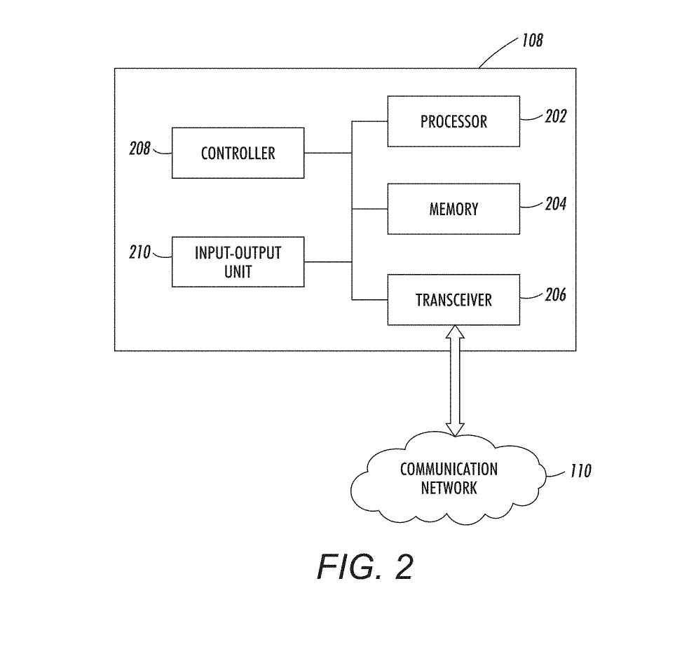

The application server 108 may be realized through various types of application servers, such as, but are not limited to, a Java application server, a .NET framework application server, a Base4 application server, a PHP framework application server, or any other application server framework. For querying the application server 108, one or more querying languages may be utilized, such as, but not limited to, SQL, QUEL, DMX and so forth. In an embodiment, the first user-computing device 102 and/or the second user-computing device 104 may connect to the application server 108 using one or more protocols such as, but not limited to, ODBC and JDBC. An embodiment of the structure of the application server 108 has been discussed later in FIG. 2.

A person having ordinary skill in the art will appreciate that the scope of the disclosure is not limited to realizing the application server 108 and the database server 106 as separate entities. In an embodiment, the database server 106 may be realized as an application program installed on and/or running on the application server 108, without departing from the scope of the disclosure.

A person having ordinary skill in the art will appreciate that the scope of the disclosure is not limited to realizing the application server 108 and the first user-computing device 102 as separate entities. In an embodiment, the application server 108 may be realized as an application program installed on and/or running on the first user-computing device 102, without departing from the scope of the disclosure.

The communication network 110 may include a medium through which devices, such as the first user-computing device 102, the second user-computing device 104, the database server 106, and the application server 108, may communicate with each other. Examples of the communication network 110 may include, but are not limited to, the Internet, a cloud network, a wireless fidelity (Wi-Fi) network, a wireless local area network (WLAN), a local area network (LAN), a plain old telephone service (POTS), and/or a metropolitan area network (MAN). Various devices in the system environment 100 may be configured to connect to the communication network 110, in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, such as Long Term Evolution (LTE), and/or Bluetooth (BT) communication protocols.

FIG. 2 is a block diagram that illustrates various components of a computing server, in accordance with at least one embodiment. With reference to FIG. 2, there is shown the computing server, such as the application server 108, which is described in conjunction with the FIG. 1. The application server 108 may include one or more processors, such as a processor 202, one or more memory units, such as a memory 204, one or more controllers, such as a controller 206, one or more input/output (I/O) units, such as an I/O unit 208, and one or more transceivers, such as a transceiver 210. A person having ordinary skill in the art will appreciate that the scope of the disclosure is not limited to the components as described herein. Various other components and specialized circuitries may also be utilized to perform the one or more pre-defined operations of the application server 108, without deviating from the scope of the disclosure.

The processor 202 may comprise suitable logic, circuitry, interface, and/or code that may be configured to execute one or more sets of instructions stored in the memory 204. The processor 202 may be communicatively coupled to the memory 204, the controller 206, the I/O unit 208, and the transceiver 210. The processor 202 may execute the one or more sets of instructions, programs, codes, and/or scripts stored in the memory 204 to detect user disengagement. Examples of the one or more pre-defined operations may include receiving one or more activity-based contextual cues and one or more behavior-based contextual cues from one or more sensors associated with the first user-computing device 102 while the user is viewing an ongoing multimedia content on the first user-computing device 102, detecting the disengagement of the first user based on the one or more activity-based contextual cues and the one or more behavior-based contextual cues, suspending streaming of the ongoing multimedia content on the first user-computing device 102, rendering one or more queries based on the detected disengagement, and controlling streaming of the suspended multimedia content on the first user-computing device 102 based on validation of responses pertaining to the one or more queries. The processor 202 may be implemented based on a number of processor technologies known in the art. Examples of the processor 202 include, but are not limited to, an X86-based processor, a Reduced Instruction Set Computing (RISC) processor, an Application-Specific Integrated Circuit (ASIC) processor, a Complex Instruction Set Computing (CISC) processor, a microprocessor, a microcontroller, and/or the like.

The memory 204 may comprise suitable logic, circuitry, and/or interfaces that may be configured to store one or more machine codes, and/or computer programs having at least one code section executable by the processor 202. The memory 204 may store the one or more sets of instructions, codes, programs, or algorithms that are executable by the processor 202, the controller 206, the I/O unit 208, and the transceiver 210. In an embodiment, the memory 204 may include one or more buffers (not shown). The one or more buffers may be configured to store the multimedia content, the one or more queries associated with one or more portions of the multimedia content, one or more pre-defined responses to the one or more queries, and/or the like. Some of the commonly known memory implementations include, but are not limited to, a random access memory (RAM), a read only memory (ROM), a hard disk drive (HDD), and a secure digital (SD) card. It will be apparent to a person having ordinary skill in the art that the one or more sets of instructions, programs, codes, and/or scripts stored in the memory 204 may enable the hardware of the application server 108 to perform the one or more predetermined operations on the multimedia content.

The controller 206 may comprise suitable logic, circuitry, interface, and/or code that may be configured to execute one or more sets of instructions stored in the memory 204. The controller 206 may be communicatively coupled to the processor 202, the memory 204, the I/O unit 208, and the transceiver 210. The controller 206 may execute the one or more sets of instructions, programs, codes, and/or scripts stored in the memory 204 to perform the one or more operations. For example, the controller 206 may operate in conjunction with the processor 202, the memory 204, the I/O unit 208, and the transceiver 210, to control a timeline of streaming of an ongoing multimedia content on the first user-computing device 102. The controller 206 may be implemented based on a number of controller technologies known in the art. The controller 206 may be a plug-in board, a single integrated circuit on the motherboard, or an external device. Examples of the controller 206 include, but are not limited to, graphics controller, SCSI controller, network interface controller, memory controller, programmable interrupt controller, terminal access controller, and/or the like.

The I/O unit 208 may comprise suitable logic, circuitry, interfaces, and/or code that may be operable to receive the one or more activity-based contextual cues and the one or more behavior-based contextual cues through the transceiver 210, from the first user-computing device 102, over the communication network 110. Further, the I/O unit 208 in conjunction with the transceiver 210 may be operable to transmit the one or more queries displayed on the user interface of the display screen of the first user-computing device 102. The I/O unit 208 may be operable to communicate with the processor 202, the memory 204, the controller 206, and the transceiver 210. Examples of the input devices may include, but are not limited to, a touch screen, a keyboard, a mouse, a joystick, a microphone, a camera, a motion sensor, a light sensor, and/or a docking station. Examples of the output devices may include, but are not limited to, a speaker system and a display screen.

The transceiver 210 comprises one or more suitable logics, circuitries, interfaces, and/or codes that may be configured to receive/transmit the one or more queries, requests, data, content, or other information from/to one or more computing devices (e.g., the first user-computing device 102, the second user-computing device 104, or the database server 106) over the communication network 110. The transceiver 210 may implement one or more known technologies to support wired or wireless communication with the communication network 110. In an embodiment, the transceiver 210 may include, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 210 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as the Global System for Mobile Communications (GSM), Enhanced Data GSM Environment (EDGE), Wideband Code Division Multiple Access (W-CDMA), Code Division Multiple Access (CDMA), Time Division Multiple Access (TDMA), Bluetooth, Wi-Fi (e.g., IEEE 802.11a, IEEE 802.11b, IEEE 802.11g, and/or IEEE 802.11n), Voice over Internet Protocol (VoIP), Worldwide Interoperability for Microwave Access (WiMAX), a protocol for email, instant messaging, and/or Short Message Service (SMS).

FIG. 3 is a flowchart that illustrates the method for detecting user disengagement, in accordance with at least one embodiment. With reference to FIG. 3, there is shown a flowchart 300 that has been described in conjunction with FIG. 1 and FIG. 2. The method starts at step 302 and proceed to step 304.

At step 304, the one or more activity-based contextual cues of the first user are received. In an embodiment, the transceiver 210 may be configured to receive the one or more activity-based contextual cues of the first user. In an embodiment, the transceiver 210 may receive the one or more activity-based contextual cues of the first user from the one or more sensors associated with the first user-computing device 102 over the communication network 110. Examples of the one or more activity-based contextual cues include one or more of, but are not limited to, an interaction of a user with one or more I/O devices (e.g., keyboard, mouse, and/or the like) of a user-computing device, an interaction of the user with an ongoing multimedia content (e.g., pause, fast-forward, timeline scrubbing, and/or the like), a tracking of an application usage by the user, and a presence of the user in front of the user-computing device. The transceiver 210 may store the received one or more activity-based contextual cues of the first user in a storage device, such as the memory 204 or the database server 106.

Further, in an embodiment, the transceiver 210 may be configured to receive the one or more behavior-based contextual cues of the first user. In an embodiment, the transceiver 210 may receive the one or more behavior-based contextual cues of the first user from the one or more sensors associated with the first user-computing device 102 over the communication network 110. Examples of the one or more behavior-based contextual cues may include one or more of, but are not limited to, a facial expression, an emotion, an eye gaze, and an eye blinking of the first user.

Prior to receiving the one or more activity-based contextual cues and the one or more behavior-based contextual cues, the transceiver 210 may receive the request for the multimedia content from the first user-computing device 102 over the communication network 110. Based on the request, the processor 202 may be configured to extract the multimedia content from the storage device, such as the database server 106 or the memory 204. Thereafter, the transceiver 210 may transmit the multimedia content to the first user-computing device 102 over the communication network 110. In another embodiment, the first user may receive the multimedia content from the second user-computing device 104 over the communication network 110. In another embodiment, the first user may retrieve the multimedia content from the database server 106 over the communication network 110.

In an embodiment, the multimedia content may include one or more portions, such that each of the one or more portions of the multimedia content is associated with a pre-defined time interval. In an embodiment, the one or more portions may correspond to one or more concepts. For example, multimedia content, such as an “educational video” is about “Newton's laws of motion.” The multimedia content includes “three portions.” The first portion corresponds to “Newton's first law of motion” for a time interval of “7 minutes.” The second portion corresponds to “Newton's second law of motion” for a time interval of “5 minutes.” The third portion corresponds to “Newton's third law of motion” for a time interval of “4 minutes.”

After receiving the multimedia content, the first user may utilize the first user-computing device 102 to watch the streaming of the multimedia content on the first user-computing device 102. A person having ordinary skill in the art will understand that the streaming of the multimedia content on the first user-computing device 102 may require the first user to accept one or more terms and conditions associated with the received multimedia content. For example, the processor 202 may not allow the first user to download the multimedia content. Further, the processor 202 may control functionalities of one or more components, for example, one or more sensors, associated with the first user-computing device 102, while the multimedia content is streaming on the first user-computing device 102.

In an embodiment, when the first user is viewing the multimedia content streamed on the first user-computing device 102, the one or more sensors associated with the first user-computing device 102 may be operable to track (i.e., detect or measure) contextual cues of the first user. The contextual cues may include at least one of the one or more activity-based contextual cues and the one or more behavior-based contextual cues. In an embodiment, the one or more sensors may be operable to track the contextual cues of the first user during each of the one or more pre-defined time intervals of the ongoing multimedia content. For example, a tactile sensor, such as a touch sensor, may be operable to detect or measure a physical interaction of the first user with one or more I/O devices of the first user-computing device 102. An accelerometer sensor may be operable to detect or measure a movement of the one or more I/O devices and other associated components of the first user-computing device 102. A microphone sensor may be operable to detect or measure sound or voice of the first user. A passive IR sensor may be operable to detect or measure a movement of the first user or other objects in front of the first user. An image capturing sensor may be operable to detect or measure a facial expression, an emotion, an eye gaze, and an eye blinking of the first user.

A person having ordinary skill in the art will understand that the scope of the disclosure is not limited to the detection of the one or more activity-based contextual cues and the one or more behavior-based contextual cues by use of the one or more sensors as described above. In an embodiment, the one or more activity-based contextual cues and the one or more behavior-based contextual cues may be detected or measured by use of various other electronic devices that are known in the art, without limiting the scope of the disclosure.

Further, in an embodiment, the one or more sensors associated with the first user-computing device 102 may transmit at least one of the one or more activity-based contextual cues and the one or more behavior-based contextual cues of the first user to the application server 108 during each of the one or more pre-defined time intervals. The transceiver 210 may receive the contextual cues transmitted by the one or more sensors and thereafter, may store the received contextual cues in the storage device, such as the database server 106 or the memory 204.

At step 306, the disengagement of the first user is detected based on the one or more activity-based contextual cues. In an embodiment, the processor 202 may be configured to detect the disengagement of the first user based on the one or more activity-based contextual cues. Examples of the one or more activity-based contextual cues may include one or more of, but are not limited to, an interaction of a user with one or more I/O devices (e.g., keyboard, mouse, and/or the like) of a user-computing device, an interaction of the user with an ongoing multimedia content (e.g., pause, fast-forward, timeline scrubbing, and/or the like), a tracking of an application usage by the user, and a presence of the user in front of the user-computing device.

In an embodiment, the processor 202 may further utilize the one or more behavior-based contextual cues of the first user to detect the disengagement of the first user. Examples of the one or more behavior-based contextual cues may include one or more of, but are not limited to, a facial expression, an emotion, an eye gaze, and an eye blinking of the first user.

Prior to the detection of the disengagement of the first user, the processor 202 may retrieve the one or more activity-based contextual cues and/or the one or more behavior-based contextual cues of the first user from the database server 106 or the memory 204. Thereafter, the processor 202 may process at least one of the one or more activity-based contextual cues and/or the one or more behavior-based contextual cues, associated with the pre-defined time interval, to detect the disengagement of the first user during the pre-defined time interval.

In an embodiment, the processor 202 may further be operable to utilize the one or more pre-defined criteria to detect the disengagement of the first user. The one or more pre-defined criteria correspond to one or more rules that are defined by an individual such as the second user. For example, a pre-defined criterion may be based on a count of instances of physical interaction of a first user with one or more I/O devices of the first user-computing device 102 while the first user watching the ongoing multimedia content during a pre-defined time interval. In such a scenario, the processor 202 may be operable to check if the count of instances of the physical interaction with one or more I/O devices is above a pre-defined threshold value. In case the processor 202 determines that the count of instances of the physical interaction of the first user with the one or more I/O devices is above the pre-defined threshold value, the processor 202 may identify or detect the first user as disengaged.

In another exemplary scenario, another pre-defined criterion may be based on a count of instances of interaction of a first user with an ongoing multimedia content while the first user is watching the ongoing multimedia content during a pre-defined time interval. In such a scenario, the processor 202 may be operable to check if the count of instances of the interaction (e.g., pause, play, forward, backward events, and/or the like) with the ongoing multimedia content is above a pre-defined threshold value. In case the processor 202 determines that the count of instances of the interaction of the first user with the ongoing multimedia content is above the pre-defined threshold value, the processor 202 may identify or detect the first user as disengaged.

In another exemplary scenario, yet another pre-defined criterion may be based on one or more images (or videos) captured by one or more image capturing devices associated with the first user-computing device 102. The processor 202 may process the one or more captured images (or videos) to determine a presence of the first user in front of a multimedia content playing device, i.e., the first user-computing device 102. In case the processor 202 determines that the first user is not present in front of the first user-computing device 102, the processor 202 may identify or detect the first user as disengaged. In another exemplary scenario, the processor 202 may process the one or more captured images (or videos) to determine one or more facial expressions or emotions of the first user. Based on the one or more facial expressions or emotions, the processor 202 may classify a state of the first user (during a pre-defined time interval) into one or more categories, such as “happy,” “satisfied,” “distressed,” “angry,” and “frustrated.” In case the processor 202 determines that the state of the first user corresponds to one or more of “distressed,” “angry,” or “frustrated,” the processor 202 may identify or detect the first user as disengaged.

In yet another exemplary scenario, the processor 202 may be operable to process the one or more captured images (or videos) to determine a count of eye blinking of the first user while the first user is watching an ongoing multimedia content. Firstly, the processor 202 may be operable to detect eyes of the first user in the one or more captured images (or videos). Thereafter, the processor 202 may detect an eye region in each of the one or more captured images (or videos). Further, the processor 202 may utilize one or more morphological operations and one or more image processing techniques to determine one or more instances of opening and closing of eyelids of the first user. The processor 202 may further utilize a count of opening and closing of eyelids in a fixed time interval to determine a count of eye blinking of the first user. In case the processor 202 determines that the count of eye blinking of the first user is above a pre-defined threshold value, the processor 202 may identify or detect the first user as disengaged.

In yet another exemplary scenario, the processor 202 may be operable to process the one or more captured images (or videos) to measure eye gaze of a first user. The processor 202 may utilize one or more techniques, known in the art, to process the one or more captured images (or videos) so as to measure the eye gaze of the first user. The processor 202 may utilize the measurement of the eye gaze of the first user to determine whether the user is engaged or disengaged. For example, if a first user is looking at the parts of a monitor most of the time, then the first user is more likely trying to engage with an ongoing multimedia content. However, if the first user is looking away from the monitor, then the first user is more likely doing something else without concentrating on the ongoing multimedia content. In such a case, the processor 202 may identify or detect the first user as disengaged.

A person having ordinary skill in the art will understand that the scope of the disclosure is not limited to the detection of the disengagement of the first user based on the one or more activity-based contextual cues and the one or more behavior-based contextual cues as described above. In an embodiment, the processor 202 may be configured to detect the disengagement of the first user based on one or more other activity-based contextual cues and one or more other behavior-based contextual cues that are not described above, without limiting the scope of the disclosure.

At step 308, the streaming of the ongoing multimedia content on the first user-computing device 102 is suspended based on the detected disengagement of the first user. In an embodiment, the processor 202 may be configured to suspend the streaming of the ongoing multimedia content on the first user-computing device 102 based on the detected disengagement of the first user. After detecting the disengagement of the first user based on at least one of the one or more activity-based contextual cues and/or the one or more behavior-based contextual cues during the pre-defined time interval of the ongoing multimedia content, the processor 202 may suspend the streaming of the ongoing multimedia content on the first user-computing device 102.

At step 310, the one or more queries are rendered on the user interface of the first user-computing device 102 based on the detected disengagement of the first user. In an embodiment, the processor 202 may be configured to render the one or more queries on the user interface, displayed on the display screen of the first user-computing device 102, based on the detected disengagement of the first user. As discussed above, the processor 202 may suspend the streaming of the ongoing multimedia content on the first user-computing device 102 based on the detected disengagement of the first user. After the suspension of the streaming of the ongoing multimedia content on the first user-computing device 102, the processor 202 may be configured to render the one or more queries on the user interface displayed on the display screen of the first user-computing device 102.

In an embodiment, the processor 202 may generate the one or more queries in real-time after the suspension of the streaming of the ongoing multimedia content on the first user-computing device 102. For example, the processor 202 may utilize one or more natural language processing techniques, known in the art, to generate one or more queries in real-time that are rendered on a user interface. For example, the processor 202 may generate one or more queries based on at least content in a portion of an ongoing multimedia content that corresponds to a pre-defined time interval. The pre-defined time interval may correspond to a time interval during which the processor 202 may have suspended streaming of the ongoing multimedia content on the first user-computing device 102. In another exemplary scenario, the processor 202 may generate the one or more queries based on at least content in the one or more portions of the ongoing multimedia content that are associated with one or more previous pre-defined time intervals.

In another embodiment, the processor 202 may retrieve the one or more queries, corresponding to the pre-defined time interval, from the database server 106. The one or more queries retrieved from the database server 106 may have been provided by the second user. Prior to the transmission of the multimedia content on the first user-computing device 102, the processor 202 may have transmitted the multimedia content to the second user-computing device 104. The multimedia content may include the one or more portions and each of the one or more portions is associated with the corresponding pre-defined time interval of the multimedia content. The second user may determine the one or more queries based on the content in the one or more portions of the multimedia content. Thereafter, the second user may transmit the one or more queries, corresponding to the one or more pre-defined time intervals of the multimedia content, to the database server 106 over the communication network 110. The processor 202 may retrieve the one or more queries from the database server 106 based on at least the pre-defined time interval during which the processor 202 may have suspended streaming of the multimedia content on the first user-computing device 102.

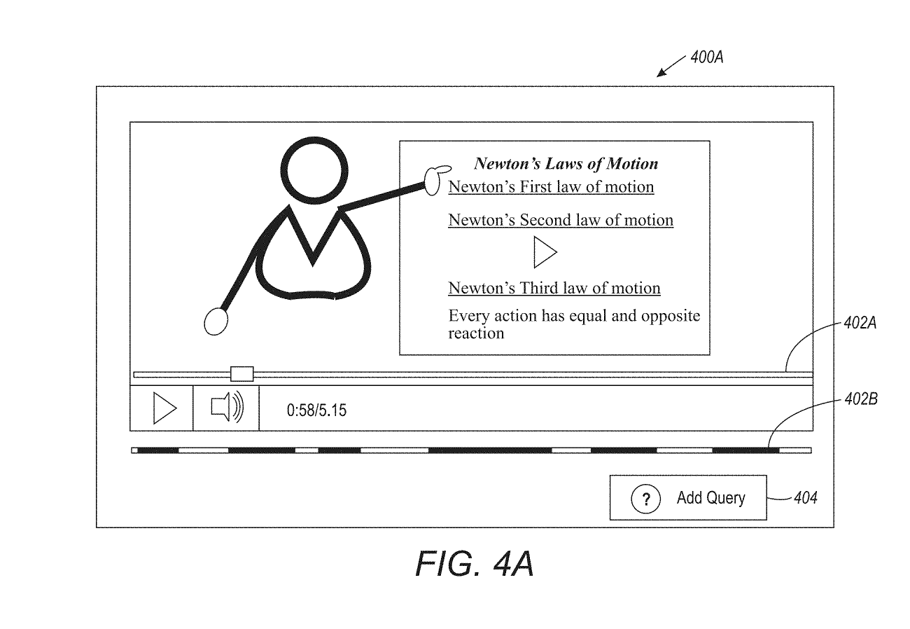

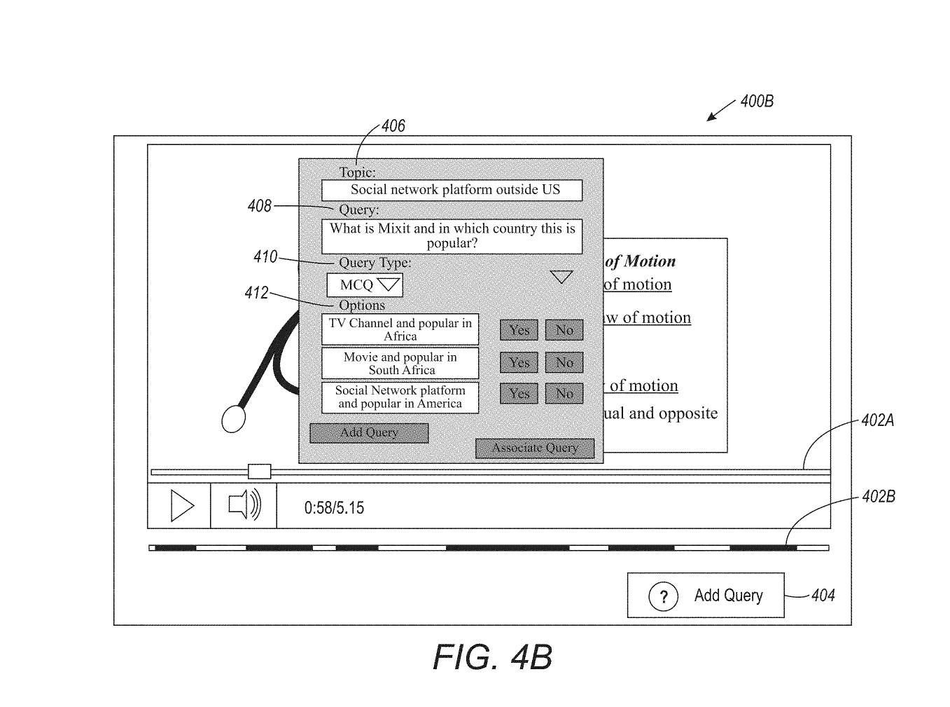

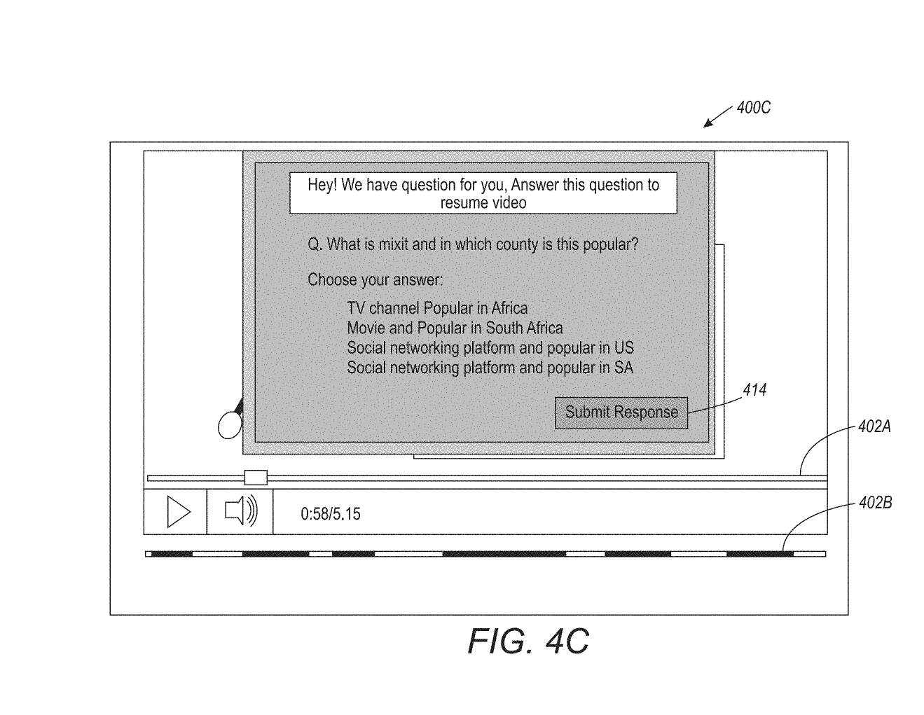

In another embodiment, the second user may have embedded the one or more queries in the one or more portions of the multimedia content. In an embodiment, the processor 202 may have rendered an interactive dashboard on the display screen of the second user-computing device 104 over the communication network 110. The interactive dashboard comprises at least the multimedia content and an option to add one or more queries pertaining to each of the one or more portions of the multimedia content. In an embodiment, the processor 202 may utilize the rendered interactive dashboard to add the one or more queries pertaining to each of the one or more portions of the multimedia content. The addition of the one or more queries pertaining to the one or more portions of the multimedia content has been explained in detail in conjunction with FIG. 4A.

After the suspension of the streaming of the ongoing multimedia content on the first user-computing device 102 based on the detected disengagement, the processor 202 may render one of the generated, retrieved, or embedded one or more queries on the user interface displayed on the display screen of the first user-computing device 102.

At step 312, the one or more responses pertaining to the rendered one or more queries are received from the first user-computing device 102. In an embodiment, the transceiver 210 may be configured to receive the one or more responses pertaining to the one or more queries from the first user-computing device 102 over the communication network 110.

At step 314, the one or more received responses are validated based on a comparison of the one or more responses with the one or more predefined responses of the one or more queries. In an embodiment, the processor 202 may be configured to validate the one or more received responses based on the comparison of the one or more received responses with the one or more predefined responses of the one or more queries.

Prior to the comparison, the processor 202 may be configured to extract the one or more pre-defined responses pertaining to the rendered one or more queries from the database server 106. The processor 202 may store the extracted one or more pre-defined responses in the memory 204. Thereafter, the processor 202 may be configured to compare the one or more received responses with the extracted one or more pre-defined responses. Further, the processor 202 may validate the one or more received responses based on at least the comparison.

At step 316, the timeline of the streaming of the suspended multimedia content on the first user-computing device 102 is controlled based on the validation of the one or more received responses. In an embodiment, the controller 206 may be configured to control the timeline of the streaming of the suspended multimedia content on the first user-computing device 102, based on the validation of the one or more received responses. For example, when the processor 202 determines that the one or more received responses are validated as correct based on the comparison, the controller 206 in conjunction with the processor 202 may be configured to resume the streaming of the suspended multimedia content from a time instant at which the ongoing multimedia content was suspended by the processor 202. However, when the processor 202 determines that the one or more received responses are validated as incorrect based on the comparison, the controller 206 in conjunction with the processor 202 may be configured to resume the streaming of the suspended multimedia content from a time instant that denotes a beginning of a pre-defined time interval. The pre-defined time interval corresponds to a time interval during which the disengagement of the first user was detected by the processor 202. In another exemplary scenario, the processor 202 may terminate the streaming of the ongoing multimedia content on the first user-computing device 102, when the processor 202 determines that the one or more received responses are validated as incorrect based on the comparison. Control then passes to end step 318.

FIG. 4A is an exemplary user interface that is rendered on the second user-computing device 104 to search multimedia content, in accordance with an embodiment. With reference to FIG. 4A, there is shown an exemplary user interface 400A that is described in conjunction with elements from FIG. 1, FIG. 2, and FIG. 3. The exemplary user interface 400A displays a streaming of multimedia content on the second user-computing device 104.

Prior to the streaming of the multimedia content on the second user-computing device 104, the second user may utilize the second user-computing device 104 to search for the multimedia content from the storage device, such as the database server 106. The second user may transmit one or more keywords to search for the multimedia content. Based on the one or more keywords, the processor 202 may query the database server 106 for the multimedia content. The database server 106 is configured to maintain the repository of multimedia content. Further, the database server 106 is communicatively coupled with one or more MOOC providers, such as “Coursera,” “EdX,” “UdaCity,” and “YouTube,” over the communication network 110. Based on the one or more keywords, the processor 202 may render a set of multimedia content on the exemplary user interface 400A displayed on the display screen of the second user-computing device 104. The second user may select the multimedia content from the set of multimedia content.

In an embodiment, the streaming of the multimedia content on the second user-computing device 104 displays a timeline 402A of the multimedia content. The exemplary user interface 400A further includes a 2-D timeline 402B that is parallel to the timeline 402A of the multimedia content. In an embodiment, the processor 202 may be configured to generate the 2-D timeline 402B. The processor 202 may generate the 2-D timeline 402B based on one or more portions or concepts associated with the multimedia content. The one or more portions or concepts correspond to one or more topics that may have been discussed in the multimedia content. In an embodiment, the processor 202 may identify the one or more concepts in the multimedia content based on at least detection of a transition from one topic to another topic in the multimedia content. The processor 202 may utilize one or more natural language processing techniques known in the art to detect the transition from one topic to another topic in the multimedia content. After the identification of the one or more portions or concepts, the processor 202 may generate the 2-D timeline 402B based on the one or more concepts. The 2-D timeline 402B may further be representative of one or more pre-defined time intervals, such that each pre-defined time interval in the 2-D timeline 402B represents a concept that has been discussed through the multimedia content.

Further, in an embodiment, the exemplary user interface 400A includes a tab, such as an add query tab 404. In an embodiment, the second user may activate the add query tab 404 to add one or more queries pertaining to the one or more pre-defined time intervals. The second user may add the one or more queries based on the one or more concepts associated with the one or more pre-defined time intervals. The second user may further add the one or more queries that are not related to the one or more concepts but are pre-requisites of the multimedia content. In an embodiment, the second user may click on a concept (or a pre-defined time interval) on the 2-D timeline 402B to navigate to different parts of the multimedia content and thereafter, add the one or more queries accordingly. The one or more queries are added as annotations that may appear during the streaming of the multimedia content on the first user-computing device 102 based on the detected disengagement of a first user associated with the first user-computing device 102.

FIG. 4B is an exemplary user interface 400B that is rendered on the second user-computing device 104 to add the one or more queries, in accordance with an embodiment. The second user may click on a tab, such as a topic tab 406, to add a topic of interest, such as “Social network platform outside of US.” Thereafter, the second user may click on a tab, such as query tab 408, to add a query, such as “What is mixit and in which country this is popular?.” Further, the second user may click on a tab, such as query type tab 410, to a type of the query, such as “MCQ.” Further, the second user may click on a tab, such as an option tab 412, to add plurality of options for the added query. Further, in an embodiment, the second user may utilize historical contextual cues of a first user to add the corresponding one or more queries.

Further, in an embodiment, the second user is provided with an option to select one or more of the one or more activity-based contextual cues and/or the one or more behavior-based contextual cues for detecting the disengagement of the first user. After the addition of the one or more queries and selection of contextual cues, the second user may transmit the multimedia content to the first user-computing device 102 or the application server 108.

FIG. 4C is an exemplary user interface that is rendered on the first user-computing device 102 based on the detected disengagement of the first user, in accordance with an embodiment. With reference to FIG. 4C, there is shown an exemplary user interface 400C that is described in conjunction with elements from FIG. 1, FIG. 2, and FIG. 3.

Prior to the detection of the disengagement, the first user may have received the multimedia content from the second user-computing device 104 or the application server 108 over the communication network 110. During the streaming of an ongoing multimedia content on the first user-computing device 102, the processor 202 may detect the disengagement of the first user. Based on the detected disengagement of the first user, the processor 202 may be configured to suspend the streaming of the ongoing multimedia content on the first user-computing device 102. Thereafter, the processor 202 may be configured to render the one or more queries on a user interface, such as the exemplary user interface 400C, displayed on the display screen of the first user-computing device 102. With reference to FIG. 4C, the exemplary user interface 400C displays a query and one or more options associated with the displayed query. The exemplary user interface 400C further includes a tab, such as a submit answer tab 414. After selecting an option from the one or more options of the displayed query, the first user may click on the submit answer tab 414 to submit the selected option as an answer to the displayed query. Based on validation of the answer, the controller 206 in conjunction with the processor 202 may be operable to control a timeline of the streaming of the suspended ongoing multimedia content on the first user-computing device 102.

The disclosed embodiments encompass numerous advantages. Various embodiments of the disclosure lead to a method and a system to detect disengagement of a first user, while the first user is watching an ongoing multimedia content. Through various embodiments of the disclosure, the disengagement of the first user is detected based on the one or more activity-based contextual cues and/or the one or more behavior-based contextual cues, while the first user is watching the ongoing multimedia content. Further, based on the detected disengagement of the first user, one or more queries are rendered on the user interface displayed on the display screen of the first user-computing device 102. Based on validation of one or more received responses pertaining to the one or more queries, the streaming of the ongoing multimedia content is controlled. Therefore, it is advantageous to render the one or more queries based on the one or more portions of the ongoing multimedia content for better attention and retention of the first user with the ongoing multimedia content.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems to detect disengagement of a first user have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skill in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method to detect user disengagement from an ongoing multimedia content requiring occasional active interaction, the method comprising:
receiving, by one or more transceivers at a computing server, one or more activity-based contextual cues of a first user viewing the ongoing multimedia content on a user computing device;
detecting, by one or more processors at the computing server, the disengagement of the first user during one or more predefined time intervals associated with the ongoing multimedia content based on at least the one or more activity-based contextual cues; and
rendering, by the one or more processors, one or more queries, based on the detected disengagement of the first user, on a user interface displayed on a display screen of the user computing device, wherein the one or more queries are determined based on at least a portion of the ongoing multimedia content that corresponds to the one or more predefined time intervals.

2. The method of claim 1 further comprising receiving, by the one or more transceivers, one or more behavior-based contextual cues of the first user viewing the ongoing multimedia content on the user computing device.

3. The method of claim 2 further comprising detecting, by the one or more processors, the disengagement of the first user during the one or more predefined time intervals based on at least the one or more behavior-based contextual cues.

4. The method of claim 1, wherein the one or more activity-based contextual cues and one or more behavior-based contextual cues are received, by the one or more transceivers, from the user computing device over a communication network, wherein the one or more activity-based contextual cues and the one or more behavior-based contextual cues are detected by one or more sensors associated with the user computing device.

5. The method of claim 4, wherein the one or more activity-based contextual cues correspond to a detection of at least one of: an interaction of the first user with one or more input/output devices of the user computing device, an interaction of the first user with the ongoing multimedia content, a tracking of an application usage by the first user, and a presence of the first user in front of the user computing device.

6. The method of claim 4, wherein the one or more behavior-based contextual cues correspond to a detection of at least one of: a facial expression, an emotion, an eye gaze, and an eye blinking of the first user.

7. The method of claim 4, wherein the one or more sensors correspond to at least one or more of a touch sensor, a pressure sensor, an image capturing sensor, an accelerometer sensor, a microphone sensor, and a passive infrared sensor.

8. The method of claim 1 further comprising suspending, by the one or more processors, streaming of the ongoing multimedia content on the user computing device based on the detected disengagement of the first user, wherein the one or more queries are rendered on the user interface after the suspension of the ongoing multimedia content on the user computing device.

9. The method of claim 8, wherein the one or more queries are generated, by the one or more processors, in a real-time based on the portion of the ongoing multimedia content that corresponds to at least the one or more predefined time intervals.

10. The method of claim 8, wherein the one or more queries correspond to one or more personalized queries provided by one or more second users, wherein the one or more second users have determined the one or more personalized queries based on at least a historical contextual cues of the first user, and wherein the one or more personalized queries are associated with the one or more predefined time intervals.

11. The method of claim 8 further comprising receiving, by the one or more transceivers, one or more responses pertaining to the one or more queries from the user computing device of the first user over a communication network.

12. The method of claim 11 further comprising validating, by the one or more processors, the one or more received responses based on a comparison of the one or more received responses with one or more predefined responses of the one or more queries.

13. The method of claim 12 further comprising controlling, by a controller at the server, a timeline of streaming of the ongoing multimedia content on the user computing device based on at least the validation of the one or more received responses and the one or more predefined time intervals associated with the ongoing multimedia content.

14. A system to detect user disengagement from an ongoing multimedia content requiring occasional active interaction, the system comprising:
one or more transceivers at a computing server configured to:
receive one or more activity-based contextual cues of a first user viewing the ongoing multimedia content on a user computing device;
one or more processors at the computing server configured to:
detect the disengagement of the first user during one or more predefined time intervals associated with the ongoing multimedia content based on at least one of the one or more activity-based contextual; and
render one or more queries, based on the detected disengagement of the first user on a user interface displayed on a display screen of the user computing device, wherein the one or more queries are determined based on at least a portion of the ongoing multimedia content that corresponds to the one or more predefined time intervals.

15. The system of claim 14, wherein the one or more transceivers are further configured to receive one or more behavior-based contextual cues of the first user viewing the ongoing multimedia content on the user computing device.

16. The system of claim 15, wherein the one or more processors are configured to detect the disengagement of the first user during the one or more predefined time intervals based on at least the one or more behavior-based contextual cues.

17. The system of claim 14, wherein the one or more transceivers are configured to receive the one or more activity-based contextual cues and one or more behavior-based contextual cues from the user computing device over a communication network, wherein the one or more activity-based contextual cues and the one or more behavior-based contextual cues are detected by one or more sensors associated with the user computing device.

18. The system of claim 17, wherein the one or more activity-based contextual cues correspond to a detection of at least one of: an interaction of the first user with one or more input/output devices of the user computing device, an interaction of the first user with the ongoing multimedia content, a tracking of an application usage by the first user, and a presence of the first user in front of the user computing device, and wherein the one or more behavior-based contextual cues correspond to the detection of at least one of: a facial expression, an emotion, an eye gaze, and an eye blinking of the first user.

19. The system of claim 14, wherein the one or more processors are further configured to suspend streaming of the ongoing multimedia content on the user computing device based on the detected disengagement of the first user, wherein the one or more queries are rendered on the user interface after the suspension of the ongoing multimedia content on the user computing device.

20. The system of claim 19, wherein the one or more processors are further configured to generate the one or more queries in a real-time based on the portion of the ongoing multimedia content that corresponds to at least the one or more predefined time intervals.

21. The system of claim 19, wherein the one or more queries correspond to one or more personalized queries provided by one or more second users, wherein the one or more second users have determined the one or more personalized queries based on at least a historical contextual cues of the first user, and wherein the one or more personalized queries are associated with the one or more predefined time intervals.

22. The system of claim 19, wherein the one or more transceivers are further configured to receive one or more responses pertaining to the one or more queries from the user computing device of the first user over a communication network.

23. The system of claim 22, wherein the one or more processors are further configured to validate the one or more received responses based on a comparison of the one or more received responses with one or more predefined responses of the one or more queries.

24. The system of claim 23, wherein a controller at the server is further configured to control a timeline of streaming of the ongoing multimedia content on the user computing device based on at least the validation of the one or more received responses and the one or more predefined time intervals associated with the ongoing multimedia content.

25. A computer program product for use with a computer, the computer program product comprising a non-transitory computer readable medium, wherein the non-transitory computer readable medium stores a computer program code to detect user disengagement from an ongoing multimedia content requiring occasional active interaction, wherein the computer program code is executable by one or more processors to:
receive one or more activity-based contextual cues and one or more behavior-based contextual cues of a first user viewing the ongoing multimedia content on a user computing device;
detect the disengagement of the first user during one or more predefined time intervals associated with the ongoing multimedia content based on at least the one or more activity-based contextual cues and the one or more behavior-based contextual cues; and
render one or more queries, based on the detected disengagement of the first user on a user interface displayed on a display screen of the user computing device, wherein the one or more queries are determined based on at least a portion of the ongoing multimedia content that corresponds to the one or more predefined time intervals.
